(19) United States
(12) Patent Application Publication
(10) Pub. No.: US 2004/0178540 A1
(43) Pub. Date: Sep. 16, 2004

(54) Method for manufacturing products with natural polymers, and such products

(75) Inventor: Jan Wietze Huisman, Bellingwolde (NL)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: Vertis B.V.

(21) Appl. No.: 10/809,002

(22) Filed: Mar. 25, 2004

Related U.S. Application Data
(63) Continuation of application No. 09/869,533, filed on Sep. 11, 2001, now abandoned.
Application No. 09/869,533 is a 371 of international application No. PCT/NL99/00817, filed on Dec. 29, 1999.

(30) Foreign Application Priority Data
Dec. 29, 1998 (NL) 1010915
Dec. 29, 1998 (NL) 1010916

(51) Int. Cl. B29C 44/02; B29D 1/00; B32B 3/26; B32B 27/00; H05B 6/00

(52) U.S. Cl. 264/478; 264/45.1; 264/51; 428/304.4; 428/319.3

(57) ABSTRACT

A method for manufacturing products, wherein a mass, comprising at least natural polymers such as starch, is brought into or through a mold and the mass in the mold is heated, such that this involves at least cross-linkage of the natural polymers, while of at least one first part of the product, the material composition is influenced such that the material properties of the relevant first part deviate from the material properties of parts adjoining said part.

The invention relates to a method for manufacturing products with natural polymers, according to the preamble of claim 1. Such method is known from U.S. Pat. No. 5,716,675.

In this known method, products are moulded from a mass comprising starch. In order to increase the flexibility and stability of said products, polyalcohol, particularly glycerin is added to said mass. Furthermore, a coating of polyalcohol is used to amend the concentration of softener in a hinge part of said products in order to amend the flexibility of said hinge part relative to the adjoining parts. To this end, the coating is supplied after gelatinization of the natural polymers in said mass in the mould, by heating the mould to a gelatinization temperature. The moulds used are baking tongs.

Furthermore, U.S. Pat. No. 5,776,388 discloses a method for producing hinging products comprising starchbound matrixes. In this method, a hinge is provided having at least one groove extending over the width of said product, the moulding of the article in a mould, by heating to a gelatinization temperature, resulting in an article having a cellular core between an interior and exterior skin, the interior skin having a thickness, at the hinge, which is less than the thickness of the exterior skin. After gelatinization the interior skin portion of the hinge can be treated with polyol. This publication does also disclose a method for forming such hinge in which less heat per unit time is imparted to the interior skin than to the exterior skin at the hinge part. Furthermore, elastomeric coatings can be applied on the articles after gelatinzation.

U.S. Pat. No. 5,683,772 discloses the manufacture of articles having a fiber reinforced starchbound cellular matrix, having an outer skin portion and an interior foam portion. The density of the interior foam portion is significantly lower than the density of the skin portions. In this publication, various organic an inorganic coatings are disclosed to be applied to said products after gelatinization of the natural polymers in the mould.

JP 09286043 discloses a method for producing plastic products in which a first, relatively hard resin and a second, relatively soft resin are use. Said resins are heated such that they are molten prior to introduction into the mould, after which they solidify in the mould, resulting in a product having two parts having different properties. In this publication therefore a 2-K injection moulding technique is disclosed for producing plastic products.

WO 95/20628 discloses a method in which a mass is introduced into a female mold of a platen set, whereupon the platen set is closed and brought to a baking temperature for some time, such that within the platen set, cross-linking of natural polymers present in the mass occurs to form a desired blown, foamy structure. In this known method, for instance, two tray-shaped parts are formed, interconnected by a relatively thin wall part having the same composition and structure as the walls of the tray-shaped parts. The relatively thin wall part should function as hinge part for enabling pivoting the two tray-shaped parts relative to each other.

This known method has the advantage that in a relatively simple manner, a product can be obtained having an integrated hinge. However, such method entails the drawback that a product thus obtained has a brittle structure, so that said hinge part, in particular the skin-shaped outer layers thereof, will be liable to tear or break upon pivoting, as will the further wall parts of this product. A further major drawback of this known method is that it necessitates long cycle times, which is disadvantageous both costwise and environmentally.

Generally, it can be argued that typically, with regard to products of the present type, having a foamy wall structure, requirements are set which have hitherto proved to be hard or impossible to combine. Thus, for instance, parts should be rigid while other parts are desired to be flexible. For packing material, for instance, it applies that it is advantageous that some parts thereof are shock-absorbing, while, conversely, other parts are form-retaining and relatively rigid. Also, with regard to parts of such products, requirements can be set concerning for instance, vapor proofness, hardness, color, brittleness, heat resistance and the like, which requirements have hitherto been difficult to combine with the requirements imposed on other parts.

Further, it is observed that WO 93/05668 teaches a method for forming products from starch-containing mass. In this method, the mass is heated prior to the feed into a mold, so that gelatinization occurs before the introduction into the mold. In the mold, the product is subsequently cooled to obtain the desired stiffness. The product obtained then contains as much moisture as the starting mass which is actually boiled. In this publication, no baking of the mass is involved, so that no closed skin is obtained.

The object of the invention is to provide a method of the type described in the preamble, in which the drawbacks mentioned of the known method are avoided, while the advantages thereof are retained. To that end, a method according to the present invention is characterized by the features of claim 1.

It has proved to be possible to manufacture products of the above-mentioned type in such a manner that the material properties, such as mentioned hereinabove, of different parts differ, through influencing thereof during or after the formation of a base product. The invention is based upon the surprising insight that the properties of at least parts of said products can be influenced when, during or after the formation of the product, as base product, components are added thereto, extraction of components therefrom is prevented, or, conversely, said components are extracted therefrom, such that the relevant components will at least partially yield the desired material properties or, respectively, the influence thereof will be reduced or inhibited.

A mass applied in a method according to the present invention is preferably biodegradable. In this context, “biodegradable” should at least be understood to mean substantially biologically degradable, at least substantially recyclable without particularly high environmental burden. Further, it should at least also be understood to mean compostable.

The use of at least two different masses offers the advantage that directly upon the formation of the (base) product, material properties are influenced specifically, at least such that after formation, each part of the product has the desired properties. Also, in this manner, one or more parts of the base product can be rendered suitable for further processing, for instance coating or printing. By such coating, the properties of the relevant part can be influenced even further.

In a further elaboration, a method according to the invention is further characterized by the features of claim 2.

It has been found that in a method according to the present invention, in which said first part deviates in concentration of softener from the other parts of the product, a part can be obtained whose pliability is greater than the pliability of the wall parts of the adjoining parts. Moreover, such part can be after-treated relatively easily, if necessary, for instance for further increasing the pliability. In this manner, a product can be obtained which has at least one part whose flexibility is higher than that of further parts. In a type of product described in the preamble, for instance, the hinging part can be designed as such first part, to obtain a hinging part capable of enduring a relatively large number of pivotal movements without damage. Moreover, this yields a product of a higher durability which will retain its pleasant appearance for a longer time. In particular, tear formation is prevented more effectively.

In this specification, “softener” should at least be understood to mean an agent whereby the motility of relatively long polymer chains in the product can be influenced, in particular be increased. Suitable softeners can be selected depending on the composition of the (bio)mass used, in particular natural polymers used therein. Further, this should also be understood to mean such a processing that in the relevant part more, at least other softener activator is obtained or maintained.

Preferably, at least a first part is processed so that a relatively high concentration of softener is obtained and/or maintained herein. In this context, “obtained” should be understood to comprise at least migration of softener to the relevant first part from the other parts of the product or addition of softener from outside, while in this context, “maintained” should be understood to comprise at least such processing that the amount of softener in the relevant first part does not decrease, while the amount of softener in the other parts of the product can in fact decrease, or that the amount of softener in the first part decreases less quickly than in the other parts of the product. Combinations hereof are possible.

Further, at this point it is noted that through the use of different masses for the formation of different parts, other properties may be influenced as well, while, moreover, product properties may be influenced in several positions, for instance hardnesses, degradability, coloring, printability or, for instance, flexibility at closing parts and the like. These masses may differ in softener as well as in other components, such as fibers, polymers, additives and the like.

In a further alternative embodiment of a method according to the invention at least said at least one first part in the mold is processed such that a relatively low concentration of softener is obtained and/or maintained herein, such that the flexibility of at least a portion of the relevant at least one first part is less than the flexibility of parts adjoining said part.

With such method, additionally rigid or brittle parts can for instance be obtained, for instance breaking edges or the like.

In a particularly advantageous embodiment, a method according to the invention is characterized by the features of claim 14.

The advantage achieved by introducing the mass into a mold under pressure, which pressure is higher than atmospheric, is that, if so desired, relatively long, narrow flow paths and a relatively great freedom of design can be obtained, while, moreover, a particularly suitable distribution of densities in the product can be realized

In particular when use is made of injection molding technique for introducing the or each mass into a mold, products having the desired favorable properties can lie obtained in a particularly economical manner. Moreover, through suitable positioning of the injection openings, desired, advantageous flow patterns can thereby be obtained, while, moreover, in a simple manner, for instance different masses can be introduced via different injection openings, and injection pressures and speeds of different injection openings can be adjusted to effect the desired distribution of the or each mass, the desired densities thereof and the like. Suitable introducing devices, positions and pressures can, for instance, also provide for a suitable positioning of fibers and polymers in, for instance, a first or further part, for instance in that fibers will be able to orient themselves in flow direction in the case of relatively long fibers and/or relatively narrow flow paths. Introducing the or each mass into a substantially closed mold under superatmospheric pressure moreover readily provides the possibility of manufacturing products whose volume of mass introduced is greater than could be contained in a mold cavity of the female platen. Due to relatively many fibers, the tear resistance of a product according to the invention can moreover be increased.

In another advantageous embodiment, a method according to the present invention is characterized by the features of claim 16.

Processing the at least one first part after removal of the product from the mold, at least after the product has been substantially formed and, optionally, baked, makes it possible in a relatively simple manner to obtain a relevant first part with properties deviating from those of further parts.

In further elaboration, a method according to the present invention is characterized by the features of claim 17.

The advantage achieved by applying a coating; at least to the or each first part on at least one side thereof, which coating comprises at least one component which is active relative to or in the relevant mass, is that in a particularly specific manner, the or each relevant component can be introduced into at least a portion of the relevant first part. Thus, for instance the flexibility, water vapor proofness, rigidity, hardness and/or printability of the part in question can readily be influenced. Further, it is noted that it is also possible to use a coating to inhibit egress of active components. Such coating need not contain any active component.

In such method, the relevant coating can, for instance, be sprayed, ironed or pasted onto the product or applied thereto in another suitable manner, for instance through inmold-labelling technique. The coating can be provided exclusively over the or each first part, but can also cover a larger part of the product, for instance one or both sides of the entire product. Through suitable drying, other properties can be locally provided for. Thus, for instance at the location of the relevant first part, an amount of heat or another type of energy, such as light, can be supplied other than onto the other parts of the product, such that at the location of the hinge part, more reactive component such as softener, softener activator or cross-linker ingresses into or through the adjacent skin of the product and other material properties are obtained, or coating properties such as hardening or drying are influenced at that location. Thus, for instance, a water-based coating or another coating with a suitable softener, in particular solvent, can he used as coating for starch-containing products. Through less strong heating (of the coating) near a flexible part, such as a hinge part, than at a distance therefrom, more water as softener or as softener activator can be provided for in the relevant part than in the other parts, which, moreover, can optionally be retained therein by the coating.

In a further alternative embodiment, a method according to the invention is characterized by the features of claim 18.

By covering at least parts of the product which adjoin the relevant first part prior to the application of the first coating, parts other than the relevant first part are readily prevented from contacting the first coating. Thus, the or each active component from the first coating will only be applied to the relevant first part, or at least result in a change of the material properties thereof.

Covering the parts adjoining the first part is preferably achieved by applying thereto a second coating which is at least substantially impermeable to the active components, such as softener from the first coating. Preferably, as second coating, a coating is used having a relatively high hardness and high resistance to moisture. In particular when the second coating is substantially impermeable to the components mentioned, the advantage achieved is that the first coating can readily be applied to the product, covering at least parts of the second coating and the or each first part. This clearly simplifies the application.

Preferably, the first coating is relatively flexible, such that tearing of the first coating upon movement of the first part is at least substantially prevented. The advantage thus achieved is that even when breakage occurs in the core of a first part, the parts connected to the relevant first part are held together, at least by said first coating. This effect will also occur when only the first coating is used.

In all advantageous further elaboration, a method according to the invention is characterized by the features of claim 29.

The advantage achieved through the provision of at least one recess in the hinge part, at least a local thinning of the relevant hinge part, is that the resistance to bending is at least locally reduced in the hinge part, while, moreover, tensile and compressive forces in respectively the outer and inner skin of the hinge part upon pivoting of the parts connected thereto relative to each other, are reduced. In this respect, it is preferred that at least one recess extend over the width of the hinge part, preferably over substantially the full width thereof By providing several recesses, this effect is enhanced.

Providing a recess when a hinge part has said concentration of softener, by pressing a suitable (mold) part therein, offers the advantage that deformation of a relevant part of the hinge part is possible in a relatively simple manner without involving tearing of at least the skin of the relevant product part. As a result, a closed skin is also retained in and adjacent the relevant recess.

Through the inclusion of softener in the hinge part, such that it is substantially prevented from flowing away to parts adjoining the hinge part, a relatively high concentration of the relevant softener in the hinge part can readily be obtained and/or retained. Through the use of softener of a relatively high viscosity and/or a relatively great molecular size and/or a low vapor pressure, flow of the relevant softener is readily prevented, at least braked. Of course, this can also be achieved through the use of a softener which is retained relatively strongly by the material of the hinge part, for instance through adhesion or cohesion.

At least partial compression of the hinge part prior to and/or during gelatinization and/or cross-linking of the natural polymers offers the advantage that at least a number of cell walls are broken, while, moreover, other cell formation will occur and, for instance, smaller cells and a higher density will be obtained. Thus, for instance, the density and the flexibility of the hinge part will substantially be determined by the skin of the hinge part, more than by the intermediate core. Also, in this manner, there is obtained a hinge part having a higher flexibility than the adjacent parts. In particular when, moreover, the softener and/or blowing agent in the hinge part is adjusted in nature and/or concentration, a particularly advantageous, flexible hinge part is obtained. It will be understood that in this or a comparable manner, the properties of other parts of products can also he adjusted, for instance for local compaction.

The invention further relates to a product having a foamy, blown structure, characterized by the features of claim 41.

Such product offers the advantage of being environmentally advantageous, while it has optimal properties for each part. Moreover, such product can be manufactured relatively quickly and simply, so that it can be obtained from preferably replaceable raw materials in a particularly economic manner. Products according to the invention are preferably biodegradable.

By providing at least one recess, in particular one or more grooves extending in the width of the hinge part, the flexibility of the hinge part is increased even further, while, moreover, hinge lines are defined. By providing these on the inside of the hinge part, an advantageous distribution of forces on the hinge part is obtained upon pivoting, while, moreover, a pleasant appearance is maintained.

The invention further relates to a mass and to a coating in particular for use with a method or for a product according to the invention, and to an injection molding apparatus therefor.

Further advantageous embodiments of a method, product, use, coating and mass are given in the subclaims and will be further specified in the following specification and examples. In the drawings:

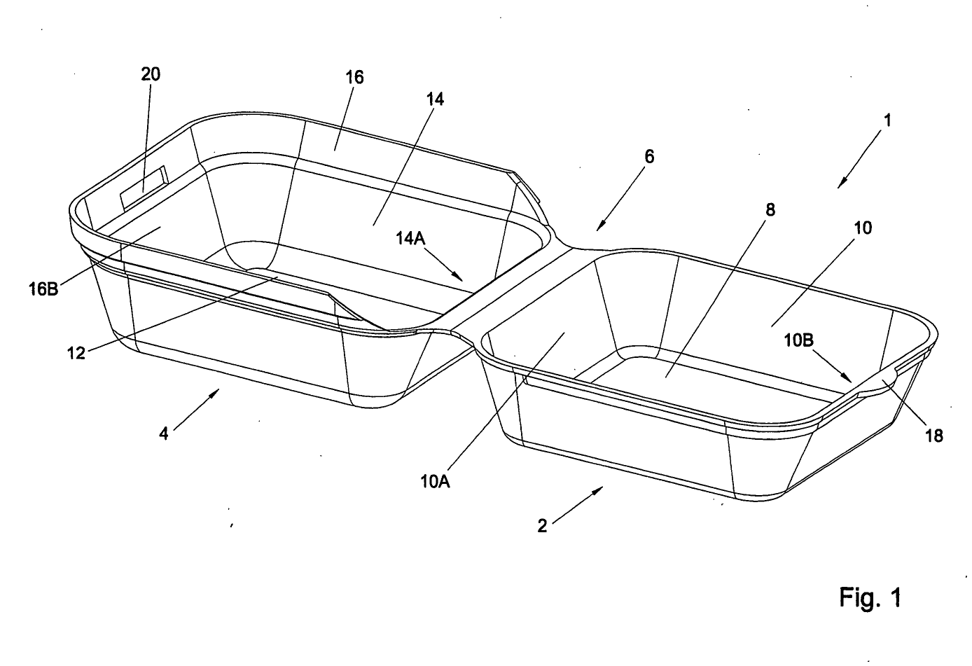

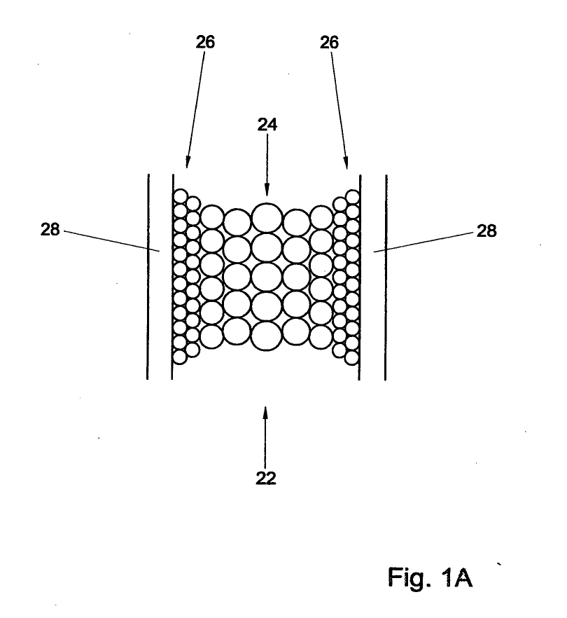

FIG. 1 shows a package, in particular a so-called claw shell as hamburger package, manufactured with a method according to the present invention,

FIG. 1A schematically shows a cross section of a wall of a product according to the invention;

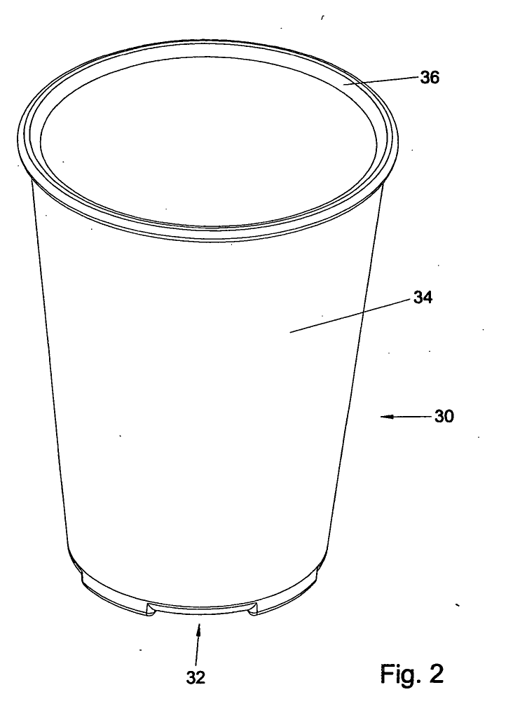

FIG. 2 shows a frustoconical container in the form of a coffee cup, manufactured with a method according to the present invention;

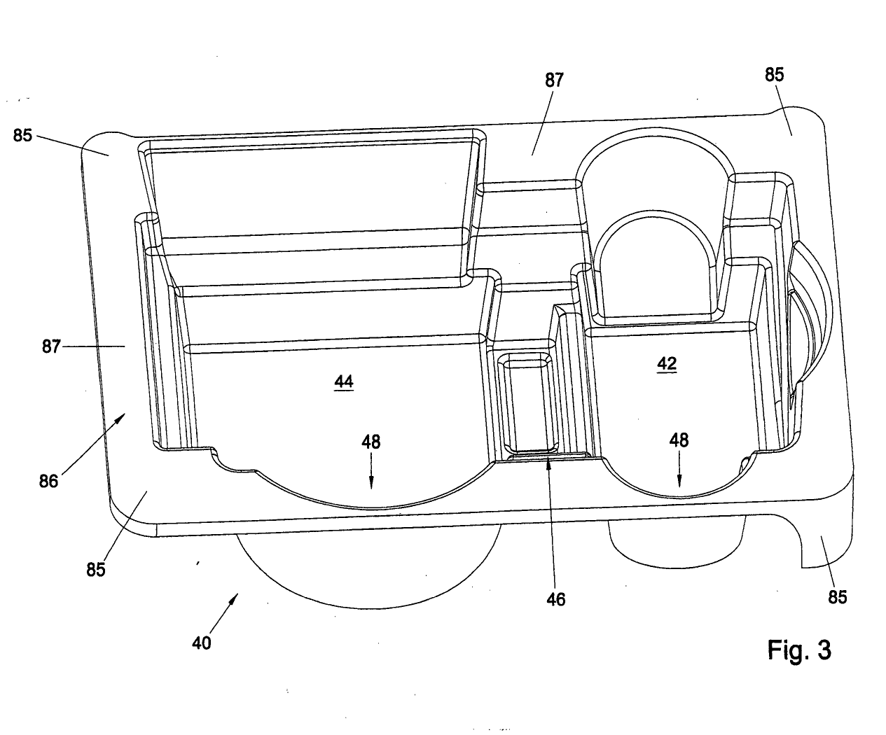

FIG. 3 shows a portion of a package, in particular an inner package for packing products, manufactured with a method according to the present invention;

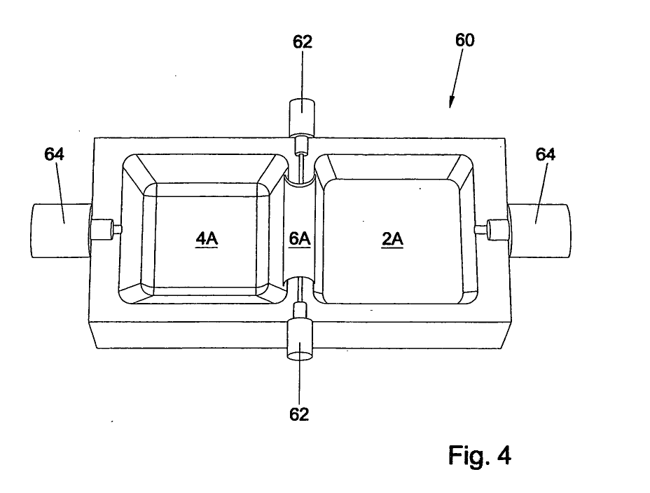

FIG. 4 schematically shows a female mold part for the formation of a container according to FIG. 1 from at least two masses;

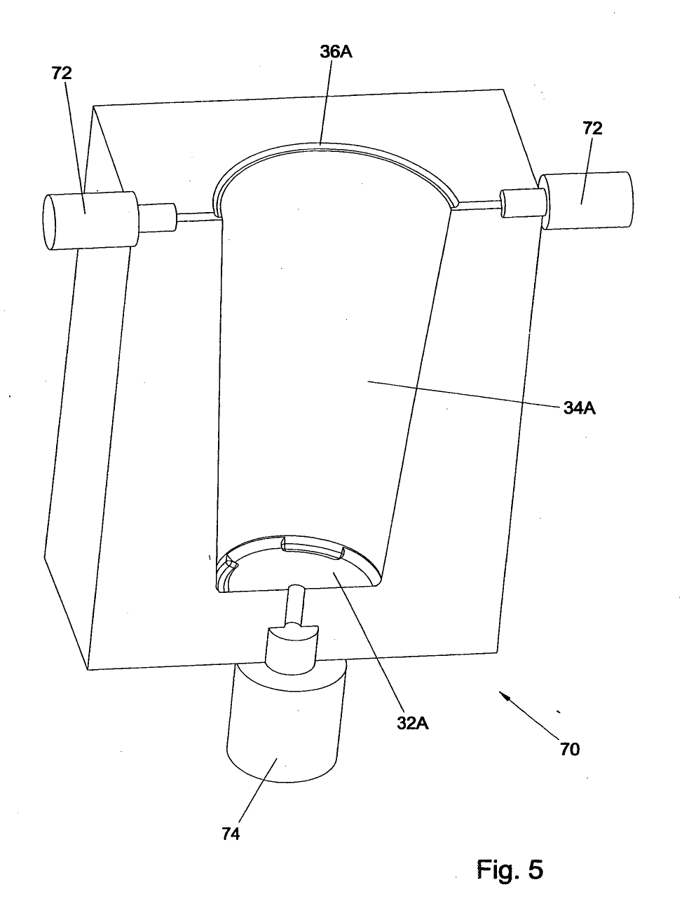

FIG. 5 schematically shows a portion of a female mold for the formation of a cup according to FIG. 2 from at least two masses;

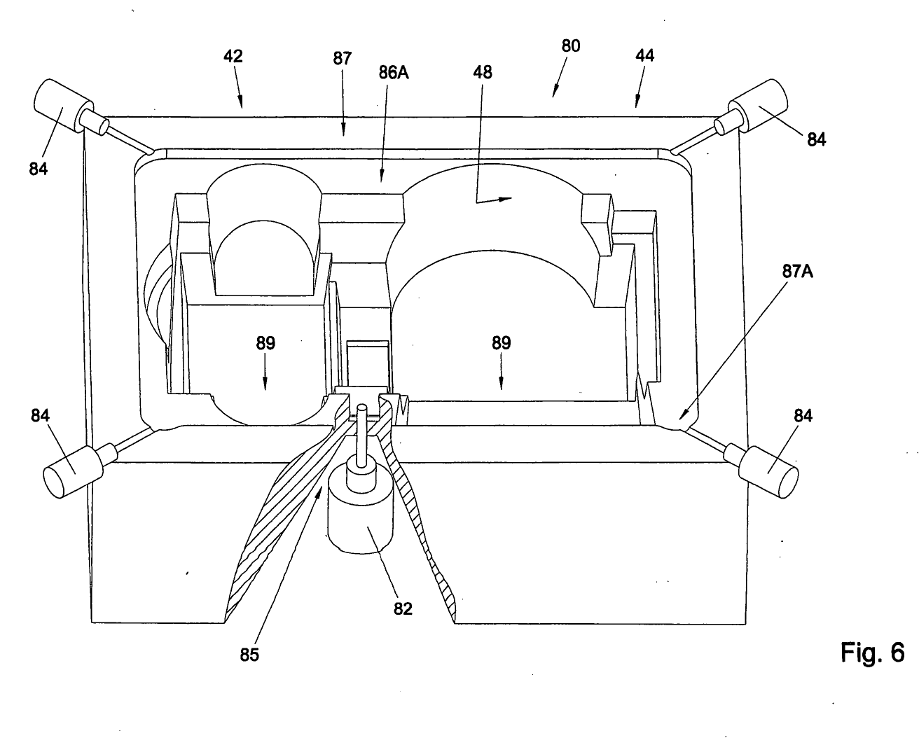

FIG. 6 schematically shows a female mold part for the formation of an inner package according to FIG. 3 from at least two masses;

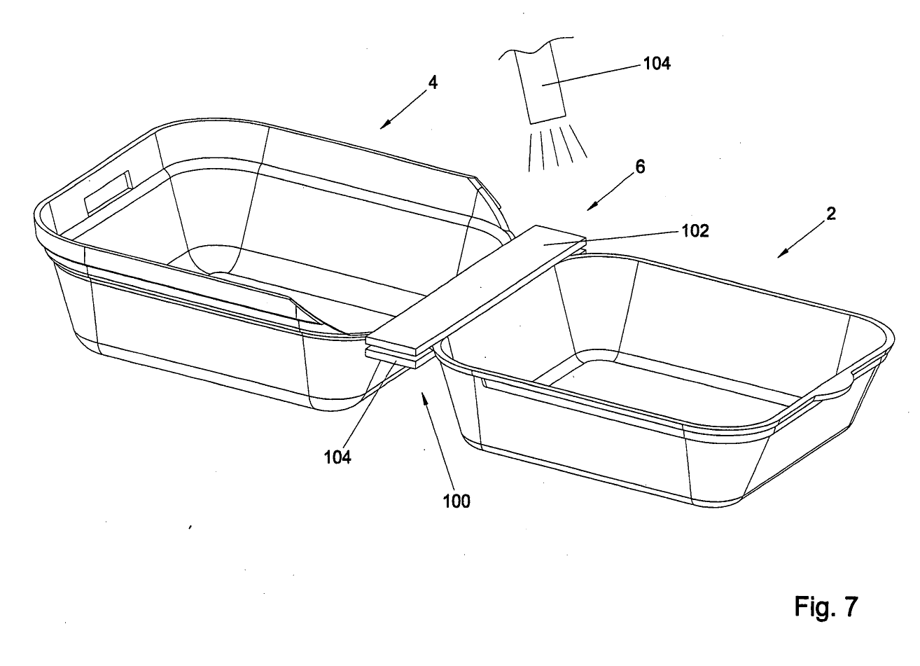

FIG. 7 schematically shows a container according to FIG. 1, clamped in at the hinge part, for applying a coating; and

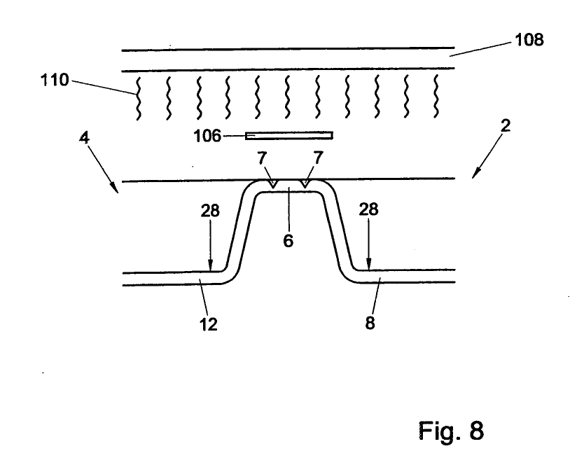

FIG. 8 schematically shows a portion of a container according to FIG. 1, in cross section, in which covering means for the hinge part are provided, during drying.

In the specification and the Figures, identical or corresponding parts have identical or corresponding reference numerals. The exemplary embodiments shown of products are given as example only and should in no way be construed as being limitative.

FIG. 1 shows, in open top plan view, a container 1 according to the invention, manufactured as a fast-food container, which is usually referred to as, for instance, clam shell. This container 1 comprises a bottom part 2 and a cover part 4, interconnected by a hinge part 6. The container 1 is manufactured by injection molding or compression molding, utilizing baking molds. These techniques will be discussed in more detail hereinbelow.

The bottom part 2 has a bottom 8 and outwardly inclined bottom longitudinal wall parts 10 extending therefrom. The cover part 4 has a top face 12 and outwardly inclined cover longitudinal wall parts 14 extending therefrom. The hinge part 6 connects a bottom longitudinal wall part 10a to an adjacent cover longitudinal wall part 14a. Provided along the other three cover longitudinal wall parts 14, along the free longitudinal edge thereof, is a closing edge 16 which, when the container 1 is closed, falls partially over the bottom longitudinal wall parts 10. The bottom longitudinal wall part 10b opposite the hinge part 6 is provided with an outwardly extending lip 18 which, when the container 1 is closed, can be received in a recess 20 provided in the closing edge 16 opposite the hinge part 6. The hinge part 6, the lip 18 and the closing edge 6 are integrally formed with the bottom part 2 and the cover part 4 and all have a blown, foamy wall structure, as shown schematically in cross section in FIG. 1A. The wall 22 has a core 24 of relatively large cells having, on either side thereof, a relatively compact skin 26 of relatively small cells. Such product is, for instance, described in international patent application PCT/NL96/00377, to be further mentioned hereinbelow and incorporated herein by reference. In FIG. 1A, a coating layer 28 is shown on either side of the wall 22. However, it will be understood that a coating 28 may also be provided on neither or only one side of the wall 22, while there may also be provided several layers of coating on one or both sides, as will be described in more detail hereinbelow. A container according to FIG. 1 is preferably completely biodegradable, thermally relatively well insulating, manufactured from materials allowed by the FDA and, moreover, preferably relatively well resistant to at least water, fat and/or oil and raised temperature, circumstances that may occur when used as fast-food container. However, this only serves as an example and containers may be designed in comparable manners, with other properties, depending on the desired field of application, as will be discussed, inter alia, with reference to the examples. The container has a bottom face having a length of 9 cm and a width of 8 cm. The vertical walls have a height of 3.5 cm and are directed outwards at an angle of 7 degrees. The wall thicknesses were averagely about 1.5 mm.

FIG. 2 is a perspective, schematic view of a cup 30 according to the invention, comprising a bottom 32 and, extending therefrom, a slightly outwardly inclined longitudinal wall 34, which is provided, on the free longitudinal edge remote from the bottom, with a slightly projecting rim 36. The cup has a height of 9 cm, with a bottom diameter of 4 cm and a wall inclined outwards through 4 degrees.

FIG. 3 is a perspective top plan view of a package part, in the shown embodiment for packing a telephone. In the description, this will be referred to as telephone tray 40. The telephone tray has two receiving cavities 42, 44, interconnected by a recess 46 and surrounded by an irregularly shaped longitudinal wall 48. The product is substantially relatively thin-walled, but may, for instance, be provided with thickenings or the like for obtaining additional firmness. Preferably, the cup according to FIG. 2 and the telephone tray according to FIG. 3 have a wall whose cross section is comparable with that of FIG. 1A and are formed by injection molding or compression molding. However, it is also possible to manufacture such products from, for instance, pressed paper.

FIG. 4 schematically shows a female mold half 60 for manufacturing the container according to FIG. 1 by injection molding from at least two masses. For this purpose, on either side of the mold half part 6a forming the hinge part 6, there is provided a first injector 62. The injection directions of the two first injectors are widthwise in respect of the hinge part. Second injectors 64 are provided in such a manner that they respectively open into the mold part 2a forming the bottom part 2 and into the mold part 4a forming the cover part 4, opposite the mold part 6a which forms the hinge part. During use of such a mold, for instance, a first mass is introduced into the hinge part-forming mold part 6a by means of the first injectors 62, whereupon a second mass is injected into the bottom part-forming mold part 2a and the cover part-forming mold part 4a respectively by means of the second injectors 64, such that at the longitudinal edges of the hinge part-forming mold part 6a, the two masses fuse together. The first and the second mass preferably provide for different properties. In particular, a relatively flexible hinge part is formed from the first mass, possibly in cooperation with a coating 28 to be applied thereto, while the bottom part 2 and cover part 4 will be formed so as to be relatively stiff, again possibly in cooperation with the or each coating 28 to be applied thereto. Of course, the position where the masses fuse together may also be chosen to be different, while, moreover, several masses may be used as well, for instance different masses for the bottom part, the hinge part and the cover part, again for obtaining different properties. Also, the same mass may be introduced by the different injectors at, for instance, different injection pressures, for obtaining other product properties.

FIG. 5 schematically shows a part of a female mold half 70 for forming a cup according to FIG. 2, with first injectors 72 opening into the part 36a which forms the rim 36, while a second injector 74 opens into the center of the mold part 32a which forms the bottom 32. Thus, different masses can be used for the rim 36 one the one hand and the bottom and the longitudinal wall 34 on the other, comparable with the manner as described with reference to FIG. 4.

FIG. 6 schematically shows a part of a female mold half 80 for forming a telephone tray according to FIG. 3, with a first injector 82 opening adjacent the center 85 of the bottom 89, while second injectors 84 open adjacent the corners 85 of the mold part 86a forming the edge 86. Thus, different masses can be used for the corner parts 85 on the one hand and the further edge parts 87, the bottom 89 and the longitudinal wall 48 on the other, comparable with the manner as described with reference to FIG. 4.

It will be understood that by means of the molds of the type as shown in FIGS. 4, 5 or 6, other properties of product parts can also be adjusted, for instance density, flexibility, hardness, looseness, color and optionally even taste and smell. Also, the surface properties thereof can be adjusted, for instance in smoothness, surface tension and the like, and in a comparable manner, other products can be manufactured.

In a mold according to the invention, slides or like moving parts can be employed in a suitable manner, with which, for instance, compartments in the mold can be separated at least temporarily. In that case, during use, different masses are introduced into the compartments on either side of such slide, and/or at different pressures, and the slide is pulled away when sufficient curing of at least one of the masses has been effected to prevent mixing. Also, such a curing can be effected, prior to the removal of the slide, that only clinging of the masses is obtained or that they only abut against each other, without bonding.

It will be understood that normal provisions have been arranged for letting off excess pressure.

In particular during the formation of packaging products, as shown in FIG. 3, it is advantageous when the outer surface of the product is smooth, in that this will involve, during use, little friction between the inner package and, for instance, an outer box or intermediate packages, which will prevent wear. Moreover, it is advantageous when the products for coating have a relatively smooth surface, which enables clearing them from the mold in a simple manner, also in the case of relatively complicated molds or relatively small clearance angles. For this, the use of release agents, such as silicone oil, stearate or wax, is advantageous.

FIG. 7 is a schematic, perspective view of a container 1 according to FIG. 1, clamped in at the hinge part 6 by means of a clamp 100. The clamp 100 comprises a top clamp part 102 and a bottom clamp part 104 whereby the top side and the bottom side respectively of the hinge part 6 are covered completely. In this condition, by means of, for instance, a spray device, of which in FIG. 7 the nozzle 104 is shown, a coating can be applied to the container 1 two-sidedly, which coating will only bond to the bottom part 2 and the cover part 4, not to the hinge part 6 covered by the clamp 6. Thus, the hinge part 6 is readily kept clear from said first coating, such that after removal of the clamp 100, a second coating can be applied to the container 1. This second coating will only contact the mass from which the container 1 is formed on the hinge part 6, not in the bottom part 2 or the cover part 4, as these are covered by the first coating. As a matter of fact, the same clamp 100 can be used during drying of the container 1, for instance with hot air, infrared or like radiation source, with the clamp 100 providing for reduced heating of the hinge part relative to the other parts. As a result, water will escape from the bottom part 2 and the cover part 4 faster than from the hinge part 6. Moisture, in particular water, will function as softener, at least as softener activator in the hinge part 6, as a result of which the hinge part 6 will be considerably more flexible than the bottom part 2 and the cover part 4. In this respect, it is preferred that next, after removal of the clamp, a coating be provided over the container, at least on the inside, such that water is at least largely prevented from possibly disappearing from the hinge part as yet.

FIG. 8 shows an alternative manner of covering the hinge part 6 during drying of the container 1 and/or a coating 28 applied thereto. At some distance above the hinge part 6, in which recesses 7 are provided, a plate 106 is provided which covers the hinge part 6. The plate may be wholly or partially impervious to the radiation 110 coming from a radiation source 108, for instance a heat radiation source, an infrared radiator, blowing means for hot air or the like. It will be understood that said radiation 110 will not reach the hinge part 6 or will do so at least less intensively, so that the bottom part 2 and the cover part 4 will dry faster than the hinge part 6. In the above-mentioned manner, this results in a particularly flexible hinge 6 and stiff bottom part 2 and cover part 4. If necessary, other parts of the container 1 may also be covered completely or partially, in a similar manner, for instance the lip 18 and/or the longitudinal edge 16 adjacent the opening 20, to be able to effect a better closure. The recesses 7 offer the advantage that the pliability of the hinge part 6 can even be further improved, tensile stresses in the skin 26 of the wall 22 and in the coating 28 are reduced and, moreover, the position of primary bending in the hinge part 6 is defined reasonably clearly.

It will be understood that different degrees of drying of parts of products may also be provided for in another manner. Thus, for instance in a package according to FIG. 2, corner parts may be dried more slowly, in order to increase the flexibility and shock absorption power thereof In the examples described hereinbelow, use is made of a number of base recipes for masses from which the base products are formed. These will be cited in the product examples by reference to Roman numerals. In so far as injection molding techniques are used, reference is made, as an example, to international patent applications PCT/NL96/00377 and PCT/NL96/00136, which are understood to be incorporated herein by reference. Similarly, use can be made of extrusion techniques described in said patent applications and of other, comparable techniques. In so far as baking molds are mentioned in this patent application, for forming products according to the invention, international patent application PCT/NL95/00083 is referred to as example, which is understood to be incorporated herein by reference. In the masses used, little to no pre-gelatinized natural polymers are used, in particular less than 5, preferably less than 3 wt. %, so that relatively long, narrow flow paths can be used in the mold. As a matter of fact, this last remark holds for any mass that can be used according to the invention.

In the examples described of masses used, use is made of, inter alia, the components given in Table 1.

TABLE 1

| Mass components: | Supplier: |
|---|---|
| silicone HY oil | OSI benelux |
| hydrocarb 95T | SA Omaya |
| china clay spec | Caldic chemie |
| hydoxyapatite | Merck |
| xanthan gum | Danby food ingredients |
| guar gum | Pomona b.v. |
| cellulose | Spencer Chemie |
| impregnated cellulose | Spencer Chemie |
| viscose | Spencer Chemie |
| hemp | Spencer Chemie |
| dicera 10102 | Paramelt |
| calcium stearate | Riedel de Haan |
| solvitose | Avebe |
| starch P10X | Avebe |
| glycerol | Merck |
| cartasol K-RL | Clariant |
| sodium bicarbonate | Merck |
| dextrin | Merck |
| polyethylene glycol | Merck |

As natural rubber, pre-vulcanized latex ML-100 was used, supplied by Wurfbain.

In the coating examples described, use is made of, inter alia, the components given in Table 2:

TABLE 2

| | Composition: | Supplier: |
|---|---|---|
| CAP504.2 | Cellulose acetate propionate | Eastman Chemical |
| HTI9102M | Synthetic wax | Hopton Technologies |
| HTI19102rp | Paraffinless synt.wax | Hopton Technologies** |
| IP12 | Isopropyl alcohol | Exachem |
| ET1 | Ethyl alcohol | Exachem |
| DVL9012.0.41 | Acrylate binder | Akzo Nobel |
| GH052 | * | P.P.G. |

*For GH052, a patent has been applied for by or at least on behalf of P.P.G., which patent application is understood to be incorporated herein by reference.
**HTI19102rp is a variant of the synthetic wax HTI19120M, which contains no paraffin and is fully repulpable. For the rest, this variant is applicable in exactly the same manner as HTI10192M, with the same results.

Mass A was prepared by mixing 1000 g of potato starch in the above-described manner with 2 g of hydroxyapatite, 75 g of china clay spec, 75 g of hydrocarb.95T, 2 g of xanthan gum, 8 g of guar gum and 120 g of cellulose fiber (white) of about 2.5 mm. This was mixed with 1500 ml of mains water in which 22 ml of silicone oil HY was dissolved, and was stirred into a liquid mass. From this, 100 g was taken, which was subsequently mixed with 15 g of glycerol, 2 g of cartasol K-RL and 4 g of polyethylene glycol.

Mass B was prepared by mixing 1000 g of potato starch in the above-described manner with 2 g of hydroxyapatite, 75 g of china clay spec, 75 g of hydrocarb.95T, 2 g of xanthan gum, 8 g of guar gum and 120 g of cellulose fiber (white) of about 2.5 mm. This was mixed with 1500 ml of mains water to which 22 ml of silicone oil HY was added, and was stirred into a liquid mass.

Mass C was prepared by mixing 1000 g of potato starch in the above-described manner with 2 g of hydroxyapatite, 75 g of china clay spec, 75 g of hydrocarb.95T, 2 g of xanthan gum, 8 g of guar gum and 120 g of cellulose fiber (white) of about 2.5 mm. This was mixed with 1500 ml of mains water and stirred into a liquid mass. From this, 100 g was taken, to be subsequently mixed with 15 g of glycerol, 2 g of cartasol K-RL and 4 g of polyethylene glycol. A base product manufactured from mass C had a surface tension of 44 dyne/cm.

Mass D was prepared by mixing 1000 g of potato starch in the above-described manner with 2 g of hydroxyapatite, 75 g of china clay spec, 75 g of hydrocarb.95T, 2 g of xanthan gum, 8 g of guar gum and 120 g of cellulose fiber (white) of about 2.5 mm. This was mixed with 1500 ml of mains water to which 2.8 g of silicone oil HY was added, and was stirred into a liquid mass. A base product manufactured from mass D had a surface tension of 33 dyne/cm.

Mass E was prepared by mixing 1000 g of potato starch, 2 g of xanthan gum and 6 g of sodium bicarbonate and adding it to 1500 ml of water in which 22 ml of silicone oil was dissolved. This was well stirred into a liquid mass.

Mass F was prepared by mixing 1000 g of potato starch with 2 g of hydroxyapatite, 75 g of china clay spec, 75 g of hydrocarb.95T, 2 g of xanthan gum, 8 g of guar gum, 60 g of hemp fiber of about 4 mm, 70 g of viscose fiber of about 8 mm and 120 g of cellulose fiber, white, of about 2.5 mm. This was stirred through 1550 ml of mains water in which 22 ml of silicone oil HY was included. From this, a liquid mass was obtained by stirring.

Mass G was prepared by mixing 1000 g of potato starch with 2 g of hydroxyapatite, 50 g of china clay spec, 50 g of hydrocarb.95T, 2 g of xanthan gum, 8 g of guar gum, 120 g of cellulose fiber, white, of about 2.5 mm, 180 g of viscose fiber of about 8 mm, 200 g of glycerol and 40 g of solvitose binder. This was stirred through 1700 ml of mains water in which 22 ml of silicone oil HY was included. From this, a liquid mass was obtained by stirring.

Mass H was prepared by mix 1000 g of potato starch with 2 g of hydroxyapatite, 200 g of china clay spec, 200 g of hydrocarb.95T, 2 g of xanthan gum, 8 g of guar gum and 120 g of cellulose fiber, white, of about 2.5 mm. This was stirred through 1600 ml of mains water in which 22 ml of silicone oil HY was included. From this, a liquid mass was obtained by stirring.

Mass J was prepared by first mixing 1000 g of potato starch with 2 g of hydroxyapatite, 300 g of china clay spec, 2 g of xanthan gum, 8 g of guar gum and 120 g of cellulose fiber, white, of about 2.5 mm. This was stirred through 1450 ml of mains water in which 22 ml of silicone oil HY was included. From this, a liquid mass was obtained by stirring. From this, 1000 g was taken, through which 20 g of dextrin, 30 g of basoplast, 50 g of glycerol and 45 g of polyethene glycol was stirred.

Mass K was prepared by mixing 1000 g of potato starch with 2 g of hydroxyapatite, 300 g of china clay spec, 2 g of xanthan gum, 8 g of guar gum and 120 g of cellulose fiber, white, of about 2.5 mm. This was stirred through 1450 ml of mains water in which 22 ml of silicone oil HY was included. From this, a liquid mass was obtained by stirring.

Mass L was prepared by mixing 1000 g potato starch, in the above-described manner, with 140 g china clay spec, 140 g of hydrocarb.95T, 2 g of hydroxyapatite, 2 g of xanthan gum, 8 g of guar gum and 120 g of cellulose fibers, white, of about 2.5 mm. This was mixed with 1500 ml of mains water, into a liquid mass.

With this mass L, base products are manufactured without release agent in a mold having adjusted inner walls, such as a teflonized aluminum mold.

Mass M was prepared as follows. 1000 g of potato starch was mixed with 120 g of impregnated cellulose fiber, of about 2.5 mm, 20 g of calcium stearate, 75 g of china clay spec, 40 g of solvitose binder, 75 g of hydrocarb.95T, 2 g of hydroyapatite, 2 g of xanthan gum, 8 g of guar gum and 120 g of viscose fiber, of about 8 mm. This was stirred with 1650 ml of mains water, as described earlier, into a liquid mash.

Into this mass M, in particular suitable for use for industrial packages, a relatively large amount of fiber is incorporated. Since such packages should have a high resistance to vibrations and shocks, a coating is applied. The surface tension appears to be substantially determined by the stearate.

Mass N was prepared as follows. 250 g of starch derivative P10X was mixed with 750 g of potato starch, to which, in the above-described manner, 5 g of Dicera 10102, 10 g of calcium stearate, 2 g of xanthan gum, 8 g of guar gum and 120 g of cellulose fiber, white, of about 2.5 mm was added. This was mixed with 1400 ml of mains water.

Mass N is an example of a mass which is in particular suitable for more technical applications, in which preferably little or no filler is present, for reasons of complete incineration after use of the product. The chosen combination of wax and stearate provides for sufficient clearance, while, moreover, a favorable surface tension is obtained

Mass O was prepared by mixing 1000 g of potato starch with 2 g of hydroxyapatite, 75 g of china clay spec, 75 g of hydrocarb.95T, 2 g of xanthan gum, 8 g of guar gum and 120 g of cellulose fiber, white, of about 2.5 mm. With 1500 ml of mains water, in which 22 ml of silicone oil HY was included, this was stirred into a liquid mass. From this, 100 g was taken, through which 75 g of natural rubber and 2 g of cartasol K-RL was mixed.

### PRODUCT EXAMPLES

The examples described hereinbelow should not be construed as being limitative in any way.

Examples 1-4 relate to fast-food containers, manufactured from two different masses.

### Example 1

A fast-food container as shown in FIG. 1 was manufactured from two different masses, in a mold as shown schematically in FIG. 4. For the hinge part 6, mass A was used, for the bottom part 2 and the cover part 4, mass B was used. To mass A, cartasol K-RL was added for obtaining a blue coloring. This provided the possibility of further observing the distribution of the two masses. Manufacturing the same container 1 from the same masses, with, however, the omission of cartasol K-RL in mass A, resulted in the same container, of course of a different color.

Mass A was introduced into the hinge-forming part 6a by means of the first injectors 62, mass B was introduced into the bottom-forming part 2a and the cover-forming part 4a by means of the second injectors 64. The introduction of mass A was started sooner than the introduction of mass B, while for the injection of mass A, a slightly higher pressure was used, in order to prevent mass A from being pressed from the hinge-forming part 6a. This is in particular important as mass A foams less quickly than mass B. Moreover, the second injectors 64 are arranged at a relatively large distance from the hinge part-forming mold part 6a, for the reason mentioned above. Table 3 shows the manner in which the container 1 was formed, in particular the interval of time, the temperatures used, the injection pressure and dosage and the events taking place at points of time stated.

TABLE 3
process description Example 1

| Time | Tₘ | | Dosage | |
|---|---|---|---|---|
| (sec) | (° C.) | P₁ (bar) | (ml) | Step/active part |
| t = 0 | 220 | n.a. | n.a. | closing of mold |
| t = 0.5 | 220 | 4 | 4 | injection of mass I/injector 1 and 2 |
| t = 2.0 | 220 | 0 | 0 | end of injection of mass I |
| t = 3.0 | 220 | 4 | 26 | injection of mass II/injector 3 and 4 |
| t = 4.5 | 220 | 0 | 0 | end of injection of mass II |
| t = 4.5 | 220 | n.a. | n.a. | start of foaming and baking |
| t = 30 | 220 | n.a. | n.a. | opening of mold |
| t = 32 | 220 | n.a. | n.a. | removal of product/remover |

Legend Table 3:
Tₘ = temperature of mold,
P₁ = pressure of injection,
Dosage = amount of mass injected.

Upon removal of the container 1 from the mold, as base product, the hinge proved to be particularly flexible, partly due to the relatively high temperature. After cooling, the flexibility decreased, for which reason the hinge part was allowed to absorb a relatively small amount of water to be able to act as softener, at least as softener activator. In the four containers manufactured in the above-mentioned manner, this was provided for in different manners.

A first container was put away for some time, to allow water vapor from the ambient air to diffuse into the container 1. This is relatively time-consuming and moreover involves the absorption of water by the entire container, hence also by the cover part and the bottom part. On the other hand, this yielded a container with a very flexible hinge part.

A second container was put away at 38° C. and 95% relative air humidity, as a result of which water was absorbed relatively quickly. Here, too, it applies that the entire container absorbed water. The container remained form-retaining and had a very flexible hinge.

For a third container, steam was blown onto the hinge part 6, as a result of which the hinge part absorbed water quickly and, moreover, the cover part and/or the bottom part was at least largely prevented from absorbing water. Thus, a flexible hinge part was obtained, while the bottom and cover parts retained their stiffness.

For a fourth container, water was provided on the hinge part to allow it to diffuse into the wall 22. In principle, this can be carried out by, for instance, spraying water thereon or providing it thereon with other means, yet in this example, a water-based coating was provided on the hinge part 6. For this purpose, in the manner shown in FIG. 7, a first coating was applied as primer to the cover part and the bottom part, which first coating was solvent-based, relatively water proof, after which said water-based coating was provided over the hinge part and the first coating. The water from the coating diffused into the hinge part and was largely stored therein, while it functioned as softener and softener activator. Thus, in a particularly simple and suitable manner, a container 1 was obtained having a particularly flexible hinge part 6, a stiff cover and bottom part, while the coatings moreover rendered the tray suitable for the desired use. Moreover, the coatings provided for enclosure of the water in the container wall parts.

The container 1 according to this example had an average wall thickness of 1.5 mm and a hinge part 6, designed as shown in FIG. 8, which endured more than 200 pivoting movements between a closed position and an open position without involving tearing. Laterally, too, the hinge part had sufficient flexibility, while the stiffness of the bottom part and the cover part was and remained very good, also when heated to above 60° C. After removal, the container had a weight of 15.1 g, while after further processing, it weighed 16.2 g. The dividing line between the first and the second mass proved to be almost completely straight, while mass A had remained almost completely limited to the hinge part 6.

### Example 2

A fast-food container according to FIG. 1 was manufactured with a mold according to FIG. 4. With the first injectors 62, mass C was introduced and with the second injectors 64, mass D was introduced. The container had a self-weight of 13.7 g before coating.

A first coating was composed from 30 g of powdery CAP504.2 which was dissolved in a mixture of 400 ml of ethyl alcohol and 100 ml of ethyl acetate, applied with a High Volume Low Pressure spraying device, type Walter Pilot 93-ND (HVLP device), at a pressure of 2.7 bar. After the coating was applied double-sidedly, it was dried in an oven at 100° C. for 20 seconds. In this example, during application of the first coating, the hinge part 6 was covered in that the container was clamped in at that location, as shown in FIG. 7. Next, a second coating was applied two-sidedly over the first coating and over the hinge part 6, which coating was prepared by mixing 600 ml of DVL9012.0.41 with 400 ml of IP 12, by means of a stirring machine (Heidolph RZR2041). The solution was transferred into the reservoir of an airless spraying machine (Nordson airless system, type 64B, pump 1 to 30), which was connected to a working pressure of 3 bar compressed air, resulting in a pressure of 90 bar in the nozzle, type cross-cut 0.03/16. This second coating was applied two-sidedly, after which the coating was dried for 20 sec. with hot air of about 60° C., by means of a drier (Ferrari 700W). Before application, the first coating had a surface tension of 30 dyne/cm, the second coating had a surface tension of 32 dyne/cm before coating. Upon application, the first layer in fact served as primer for increasing the surface tension and as barrier to water included in the second coating, at least for the bottom part 2 and the cover part 4.

Because during application of the second coating, the hinge part 6 was not protected by the at least temporarily properly water-resistant first coating (surface tension 38 dyne/cm) and the hinge part had a relatively high surface tension (44 dyne/cm), relatively much water was soaked up by the hinge part 6, in particular water from the second coating. Since water functions as softener, or is at least softener-reinforcing for the glycerol for the relevant mass, a hinge part was obtained which was particularly flexible, in particular considerably more flexible than the cover part and bottom part. After coating and drying, the container had a weight of 17.6 g, a surface tension of 20 dyne/cm and a WVT rate of 8 g/m²/24 h. During coating, the hinge part absorbed 0.3 g of water, while the bottom part and the cover part did not absorb any water.

This container had a particularly good WVT rate, while only the hinge part absorbed water during coating. As a result, the container had a particularly dry microclimate, in particular in the bottom part and the cover part, so that it was properly resistant to heat and water (vapor) proof, and had a particularly flexible hinge part, while the cover part 4 and the bottom part 2 were relatively stiff, form-retaining and strongly coated. The bonding of the coatings was good, in particular on the hinge part.

### Example 3

A fast-food container was manufactured as described in Example 2. However, an alternative mass C was used, in which no glycerol was included. As a result, the softener effect in the hinge part of the container was mainly provided by the water included therein.

### Example 3A

A fast-food container was manufactured as described in Example 2, while, however, blue colorant was added (2 g of cartasol K-RL) to the mass for forming the cover part and the hinge part. Thus, a container of an even more pleasant appearance was obtained.

### Example 4

A fast-food container was manufactured according to Example 1, while, however, mass O was used instead of mass A. A container 1 manufactured according to this example had a particularly flexible hinge part, independent of temperature and moisture, while the hinge part could be of a relatively thin design. These advantageous effects were achieved in particular through the use of natural rubber instead of softener.

### Example 5

A tray for packing shavers, comprising a bottom box and a cover to be used separately therefrom, was manufactured from two masses in a manner to be described in more detail hereinbelow. This tray was injection molded in one piece in a mold comparable with the mold as shown in FIG. 4, such that the cover could readily be broken loose from the bottom box, in that they were connected by breaking edges. As to its construction, the tray was comparable with the holder according to FIG. 1, but the hinge part 6 included therein was in this tray designed as the breaking edge mentioned. The breaking edges were manufactured from mass E, introduced by first injectors 62, the bottom box and the cover were manufactured from mass F, introduced by the second injectors 64. Injection of mass E was again started slightly earlier than injection of mass F, for reasons mentioned earlier.

Table 4 demonstrates the process for manufacturing the tray, in particular the interval of time, the temperatures involved, the injection pressures and dosage, and the events occurring at the different points of time.

TABLE 4
process description Example 5

| Time | Tₘ | | Dosage | |
|---|---|---|---|---|
| (sec) | (° C.) | P₁ (bar) | (ml) | Step/active part |
| t = 0 | 200 | n.a. | n.a. | closing of mold |
| t = 0.5 | 200 | 4 | 14 | injection of mass I/injector 1 |
| t = 1 | 200 | 0 | n.a. | end of injection of mass I |
| t = 3 | 200 | 4 | 110 | injection of mass II/injector 2 and 3 |
| t = 3.5 | 200 | 0 | 0 | end of injection of mass II |
| t = 3.5 | 200 | n.a. | n.a. | foaming and baking |
| t = 99 | 200 | n.a. | n.a. | opening of mold |
| t = 101 | 200 | n.a. | n.a. | removal of product/remover |

Legend Table 4:
Tₘ = temperature of mold,
P₁ = pressure of injection,
Dosage = amount of mass injected.

The tray according to this example could be released from the mold in one piece, while substantially only the breaking edge was formed from mass E. In particular due to the blowing agent (in this example sodium bicarbonate, other blowing agents are of course also applicable) in mass E, relatively large cells were obtained therein, as a result of which the relevant part, after formation, had a relatively brittle, fragile structure, partly due to the lack of filler such as hydrocarbonate and china clay spec. On the other hand, the bottom box and the cover had a rigid, relatively stiff structure which nevertheless proved to be sufficiently flexible for retaining a shaver to be packaged. The two parts could easily be separated during the packaging of the shaver, so that the packing could be used fully automatically.

Directly after removal from the mold, the tray weighed 58.3 g and had an average wall thickness of 3.0 mm. The end weight of the tray was 62.5 g. After separation of the two parts, these parts had a smooth, straight breaking edge.

### Example 6

A packing for a telephone, as shown in FIG. 3, was manufactured from two different masses, in a mold as described with reference to FIG. 6. With the two masses, the intention was to provide a packing having corners and, if necessary, edges that are well shock-absorbing, for instance for enduring falling without damages, at least to the telephone, while the packing can nevertheless be manufactured in an economical manner. For that purpose, mass G was injected into a mold according to FIG. 6 by the second injector 84, while mass H was injected by the first injectors 82.

Table 5 shows the process for manufacturing the packing, in particular the interval of time, the temperatures involved, the injection pressures and dosage, and the events occurring at the different points of time.

TABLE 5
process description Example 6

| Time | Tₘ | | Dosage | |
|---|---|---|---|---|
| (sec) | (° C.) | P₁ (bar) | (ml) | Step/active part |
| t = 0 | 240 | n.a. | n.a. | closing of mold |
| t = 0.5 | 240 | 6 | 45 | injection of mass I/injector 1, 2, 3, 4 |
| t = 2 | 240 | 0 | n.a. | end of injection of mass I |
| t = 3 | 240 | 6 | 98 | injection of mass II/injector 5 |
| t = 4.5 | 240 | 0 | 0 | end of injection of mass II |
| t = 4.5 | 240 | n.a. | n.a. | foaming and baking |
| t = 96 | 240 | n.a. | n.a. | opening of mold |
| t = 98 | 240 | n.a. | n.a. | removal of product/remover |

Legend Table 5:
Tₘ = temperature of mold,
P₁ = pressure of injection,
Dosage = amount of mass injected.

After manufacture of the packing as base product, it was put away for some time at room temperature in an environment having a relative air humidity of 60% (+ or −15%) in order to optimize the degree of humidity of the product. After removal, the packing had a weight of 65.2 g and wall thicknesses of averagely 3 mm. The end weight was 68.5 g.

Mass G, from which the corner parts 85 of the edge 86 were formed, contained relatively many fibers, which were moreover relatively long compared with the fibers in mass H. In addition, the corner parts 85 were more flexible and less brittle than the other parts, so that they were particularly well shock-absorbing. Because only the corner parts 85 were manufactured from mass G, which is relatively costly in particular due to the fibers used, while the further packing was manufactured from less expensive mass H, the packing could be produced in an economically advantageous manner, in particular also because a packing entirely manufactured from mass G would result in longer cycle times and the clearance thereof would be complicated considerably, due to the flexibility.

The corner parts were entirely manufactured from mass G and the masses G and H were slightly mixed adjacent the corner parts, prior to cross-linkage. In the edge 86, some variation of the mass ratios could be perceived, while, however, there was nowhere an exclusive presence of mass H.

With the packing, a standard falling test was performed, in which the packing, filled, fell from a height of 1 m, on a point. By a packing according to Example 6, this test was borne considerably better than by a comparable packing entirely manufactured from mass H.

### Example 7

A cup according to FIG. 2, with a content of 0.4 1, was manufactured from two masses, in a mold according to FIG. 2. The rim 36 was designed as clamping edge for a cover and manufactured from mass J, while the wall 34 and bottom 32 were manufactured from mass K. Mass J was injected by the first injectors 72, mass K was injected by the second injector 74. For this cup, a plastic cover was used, of the type conventional in a fast-food environment.

Table 6 shows the process for manufacturing the cup, in particular the interval of time, the temperatures involved, the injection pressures and dosage, and the events occurring at the different points of time.

The cup 30 was form-retaining and firm, while the top rim 36 had just sufficient flexibility and hence resilience to enable pressing the cover onto the rim 36, such that the cover was retained sufficiently by said rim 36. Upon leaving the mold, the cup 30 had a weight of 10.2 g and a wall thickness of 1.5 mm. Eventually, after moistening, the cup had a weight of 12.0 g.

### Example 8

In an eightfold mold, combusto cones were manufactured, interconnected by star-shaped injection channels, fed from two injectors. The combusto cones were frustoconical cups having a wall thickness of 1 mm, a height of 18 mm and an average section of 13.5 mm. By means of a first injector, mass N was forced through the injection channels, sufficient for filling the eight mold cavities, which were particularly small, after which mass E was forced into the injection channels by means of a second injector, thereby displacing mass N into said mold cavities. Next, cross-linkage of the natural polymers was effected in the mold cavities and the injection channels. After the products were baked, they were taken out of the mold. The injection channels formed from mass E had a brittle structure, while the cones were relatively stiff and rigid, so that the cones could easily be broken loose from the injection channels. Such cones are described in the patent application titled “Method for manufacturing coated products”, filed on the same day.

Examples 9-11 relate to the use of coatings for improving, at least adjusting material properties of products. In the above-cited patent application titled “Method for manufacturing coated products”, filed by applicant on the same day, further examples of such coatings and the use thereof are given, which are considered to be incorporated herein by reference. With this, properties such as hardness, flexibility, water (vapor) proofness, brittleness, moisture sensitivity and heat resistance can be further influenced, in particular also when different masses are used for different parts.

### Example 9

In this example, a coating was composed from 60 vol. % of HTI 9102 and 40% of ET1. Due to the relatively high volume of ET1, the wax proved to be readily processable. In the manner described in Example 2, the coating was applied to a cup manufactured from mass N having a self-weight of 19 g and a surface tension of 32 dyne/cm according to FIG. 2, after which the cup was dried with air of 50° C., for 25 sec. Before application, the coating had a surface tension of 32 dyne/cm, after drying this was 21 dyne/cm. As appeared from the different examples, the surface tension of the coatings decreased by about 2-3 dyne/cm when applied at a temperature of about 40-50° C. This held both for heating of the coating and for the application thereof to warm base products. Thus, the coating was further improved.

The WVT rate of this coating was 20 g/m²/24 h. The coating was well flexible and bonded well to the base product, while a reasonably good film coating was obtained. Thus, a heat-resistant cup with advantageous properties was obtained.

### Example 10

To a fast-food container manufactured from mass L having a self-weight of 16.0 g and a surface tension of 40 dyne/cm, a coating was applied double-sidedly by means of an HVLP device with a 2.0 mm nozzle and a pressure of 2.2 bar. The coating was composed from 50 vol. % of DVL9012.0.41, 35 vol. % of IP 12 and 15 vol. % of mains water of 50° C. As solution, the coating had a surface tension of 35 dyne/cm. During application of the coating, the container absorbed 1.4 g of water. The coating was dried for 25 sec. with air of 60° C. and, after that, had a weight of 18.8 g, the coating had a surface tension of 20 dyne/cm and a WVT rate of 40 g/m²/24 h. The well-bonding and film forming coating was particularly flexible.

This coating has a good WVT rate, although during the application, relatively much water ends up in the substrate, as a consequence of which the product becomes heavier and is not particularly well resistant to temperatures above about 60° C. However, the flexibility of this coating is excellent, it does not break or tear during movement or pivoting of product parts relative to adjoining product parts.

### Example 11

A tray for packaging a telephone, as shown in FIG. 3, was manufactured from mass M. It had a self-weight of 68.4 g and a surface tension, before coating, of 34 dyne/cm.

A coating was composed from 80 vol. % of GH 052 and 20 vol. % of IP 12. This coating was applied to the tray on all sides with an HVLP spraying device with a 1.3 mm nozzle at a pressure of 2.4 bar. Next, the coating was dried for 45 sec. with air of 60° C. During coating, the tray absorbed 3.2 g of water, while the weight of the tray, after drying, was 78.2 g. Before application, the coating had a surface tension of 31 dyne/cm, after drying it had a surface tension of 42 dyne/cm and a WVT rate of 70 g/m²/24 h.

Although this solution proved to be unstable, it is well processable, in particular when stirred intermittently or continuously.

Through addition of the surface tension-reducing IP 12, a coating was obtained which flattens well during application and hence provided a particularly good film formation. The coating had no particularly low WVT rate and the product absorbed relatively much water. The coating was particularly firm and rigid after drying, while sufficient flexibility was nevertheless maintained.

The invention is in no way limited to the embodiments shown and described in the description and the Figures. Many variations thereof are possible within the framework of the invention as defined by the appended claims.

Thus, more than two masses may be used in the same product, for obtaining the desired properties. Also, more or other coatings may be used one over the other. Preferably, the recesses be provided in a hinge part when relatively much softener is present therein, to obtain optimal properties. Optionally, during or directly after the formation of a product, a hinging part may be slightly compressed, such that a portion of the cell structure is broken, whereupon the hinge part will in particular function through the skin on other side and, possibly, the coatings. Further, many other types of products may of course be composed and manufactured in comparable manners, while masses and/or coatings may be selected depending on the desired properties.

1. A method for manufacturing products (1, 30, 40), wherein a mass, comprising at least natural polymers such as starch, is brought into or through a mold (60, 70, 80) and the mass in the mold is heated, such that this involves at least cross-linkage of the natural polymers, while of at least one first part (6, 36, 85) of the product (1, 30, 40), the material composition is influenced such that the material properties of the relevant first part (6, 36, 85) deviate from the material properties of parts adjoining said part characterized in that the at least one first part is formed from a second mass having a composition different from that of the first mass from which at least one part and preferably all parts (2, 4, 32, 36, 87, 89, 48) adjoining the relevant first part (6, 36, 85) are formed.

2. A method according to claim 1, wherein at least said at least one first part (6, 36, 85) in the mold is formed such that a relatively high concentration of softener is obtained and/or maintained herein, such that the flexibility of the relevant at least one first part (6, 36, 85) is greater than the flexibility of parts (2, 4, 32, 36, 87, 89, 48) adjoining said part.

3. A method according to claim 1 or 2, wherein the second mass is selected from a group of masses comprising relatively much softener and/or softener retaining components, such that after the manufacture of the product, so much softener or softener of such nature remains behind in the relevant first part (6, 36, 85) that the pliability thereof is greater than the pliability of wall parts of parts (2, 4, 32, 36, 48, 87, 89) adjoining said part.

4. A method according to claim 1, wherein the second mass is selected from a group of masses comprising relatively little softener or softener retaining components, such that after the manufacture of the product, such a small amount of softener or softener of such nature remains behind in the relevant first part (6, 36, 85) that the brittleness of at least a part thereof is greater than that of wall parts of parts (2, 4, 32, 36, 48, 87, 89) adjoining said part.

5. A method according to any one of claims 1-4, wherein the first and second masses are selected from groups of masses having different types and/or amounts of fibers, the second mass is selected such that after the manufacture of the product, a concentration and/or orientation of fibers is obtained and/or a type of fibers is included in the relevant first part (3, 36, 85) which deviates from the concentration, orientation and/or nature of any fibers present in other parts (2, 4, 32, 36, 48, 87, 89).

6. A method according to any one of claims 1-5, wherein the first and second masses are selected from groups of masses having different types and/or amounts of blowing agents and/or fillers, the second mass is selected so that at least during the manufacture of the product, a concentration of and/or a type of blowing agent and/or filler is obtained in the relevant first part (6, 36, 85) which deviates from that in other parts (2, 4, 32, 36, 48, 87, 89) of the product, to obtain a product in which, in the relevant first part (6, 36, 85), a structure is realized whose density deviates from the density of other parts (2, 4, 32, 36, 48, 87, 89) of the product.

7. A method according to any one of claims 1-6, wherein the first and second masses are selected from groups of masses having different types and/or amounts of colorants, wherein the second mass is selected so that in the relevant first part (6, 36, 85), a concentration of and/or a type of colorant is obtained which deviates from that in other parts (2, 4, 32, 36, 48, 87, 89) of the product, to obtain a product in which the relevant first part (6, 36, 86) has a color deviating from that of other parts (2, 4, 32, 36, 48, 87, 89) of the product.

8. A method according to any one of claims 1-7, wherein the first and second masses are selected from groups of masses having different types and/or concentrations of cross-linkers, wherein the second mass is selected so that at least during the manufacture of the product, a concentration of and/or a type of cross-linkers is obtained in the relevant first part (6, 36, 85) which deviates from that in other parts (2, 4, 32, 36, 48, 87, 89) of the product, to obtain a product in which the relevant first part (6, 36, 85) has a structure whose density deviates from the density of other parts (2, 4, 32, 36, 48, 87 89) of the product.

9. A method according to any one of claims 1-8, wherein the second mass is introduced between two flows of first mass.

10. A method according to any one of claims 1-9, wherein the second mass is introduced into a mold in a zone forming the relevant first part (6, 36, 85), while the first mass is introduced into a number of zones forming parts (2, 4, 32, 36, 48, 87, 89) adjoining said first zone, such that in the closed mold, the first mass and the second mass are forced against each other and interconnected.

11. A method According to any one of claims 1-10, wherein the first and the second mass in the mold are interconnected prior to or at the start of the occurrence of cross-linkage of the natural polymers.

12. A method according to any one of claims 1-11, wherein the list mass and the second mass are introduced into the mold out of phase, while preferably the introduction of the second mass is started prior to the introduction of the first mass.

13. A method according to any one of claims 1-12, wherein the first mass in the mold is subjected to a first pressure and the second mass in the mold is subjected to a second pressure, the first pressure deviating from the second pressure.

14. A method according to any one of the preceding claims, wherein the or each mass is introduced into the mold under a pressure higher than atmospheric, preferably through injection molding.

15. A method according to any one of the preceding claims, wherein at least three different masses are used for the manufacture of the product.

16. A method according to any one of the preceding claims, wherein at least the at least one first part (6, 36, 85), after formation in the mold, is processed such that the material properties of said relevant first part (6, 36, 85) are changed, at least relative to parts (2, 4, 32, 36, 48, 87, 89) adjoining said part (6, 36, 85).

17. A method according to any one of the preceding claims, wherein to at least a portion of the at least one first part (6, 36, 85), a first coating is applied, said coating comprising at least a component active with the relevant first mass, such that between the relevant active component and the mass, there is obtained a reaction whereby the material properties of the relevant first part (6, 36, 85) are influenced.

18. A method according to claim 17, wherein at least the parts (2, 4, 32, 36, 48, 87, 89) adjoining the first part (6, 36, 85) are covered prior to the application of the first coating.

19. A method according to claim 18, wherein parts (2, 4, 32, 36, 48, 87, 89) adjoining the first part (6, 36, 85) are at least partially covered by a second coating, substantially impermeable to said reactive component of the first coating, such that the first part (6, 36, 85) is at least partially kept clear of the second coating.

20. A method according to claim 19, wherein a second coating is used having a high hardness relative to the first coating, a relatively low permeability and high resistance to at least said reactive component.

21. A method according to claims 19 and 20, wherein the first coating is applied over the second coating.

22. A method according to any one of claims 17-21, wherein as first coating, a water-based coating is used.

23. A method according to any one of claims 17-22, wherein as first coating, a relatively flexible, elastic coating is used.

24. A method according to any one of claims 17-23, wherein at first coating, a coating is used comprising a number of constituents from the group of: acrylic binders, latices, styrene-butadiene latex, polyvinyl alcohol, polyvinyl acetate, polyacrylates, polyethylene glycol, polylactic acid, synthetic polymers, natural polymers, natural waxes, synthetic waxes (for instance ionic polyethylene waxes) or derivatives thereof or combinations of the preceding.

25. A method according to any one of claims 19-24, wherein as second coating, a coating is used comprising a number of constituents from the group of:
melamine, acrylic binders, water-resistant lacquers (for instance cellulose lacquer), cellulose acetate propionates, polyethylene, polyacrylates, synthetic polymers, natural polymers, synthetic waxes, natural waxes, polylactic acid, derivatives thereof or combinations of the preceding.

26. A method according to claim 24 or 25, wherein cross-linkers are incorporated into the first and/or second coating, in particular from the group of zirconium acetate, ammonium zirconium carbonate, urea formaldehyde, melamine formaldehyde, glyoxal, polyamideamine-epichlorohydrin, epoxides, trimetaphosphate, derivatives thereof or combinations of the preceding.

27. A method according to any one of claims 24-26, wherein in the first coating, at least one of the waxes is combined with at least one of the said other constituents.

28. A method according to any one of claims 24-27, wherein the first, respectively second coating is formed almost entirely from one of said other constituents.

29. A method according to any one of the preceding claims, wherein the first part (6, 36, 85) is designed as a hinge part 6 having at least one recess, in particular at least one groove extending over the width of the hinge part is provided.

30. A method according to any one of the preceding claims, wherein into the first part (6, 36, 85), after cross-linking of the natural polymers, a softener is introduced.

31. A method according to any one of the preceding claims, wherein a reactive component is incorporated into the first part (6, 36, 85), outside the mold, while it is at least substantially prevented from flowing away to the other parts, preferably a softener having a relatively large particle size and/or high viscosity.

32. A method according to claim 38, wherein as reactive component, at least a fatty, oily or waxy ingredient or the like is used.

33. A method according to any one of the preceding claims, wherein as softener, at least one from the following group is used: water, polyols, glycol, glycerol, glycerin, polyethylene glycol, polypropylene glycol, propylene glycol, sorbitol, glucose, derivatives thereof or combinations of preceding softeners.

34. A method according to any one of the preceding claims, wherein at least during a portion of the cross-linking of the natural polymers, the first part is at least partially compressed.

35. A method according to any one of the preceding claims, wherein in or on at least the first part, an active component is provided for adjusting the surface tension of at least said first part of the product with cross-linked natural fibers, in particular for increasing the surface tension.

36. A method according to any one of the preceding claims, wherein to at least a part of the product, a coating is applied whose surface tension is approximately equal to or lower than the surface tension of the product part to which the coating is applied.

37. A method according to any one of the preceding claims, wherein a coating is applied to the product, said coating comprising cross-linkers for the mass, in particular natural polymers incorporated therein.

38. A method according to any one of the preceding claims, wherein at least two coatings are applied at least partially one over the other, at least one of the coatings comprising an active component capable of reacting with the at least one other coating.

39. A method according to claim 38, wherein as active component, at least cross-linkers are used.

40. A method according to any one of claims 17-39, wherein the product is gripped at the first part (6, 86, 85), such that it is covered at least substantially completely, after which the second coating is applied to other parts (2, 4, 32, 36, 48, 87, 89), in particular sprayed thereon, after which the first part is released and, after that, the second coating is applied, in particular sprayed thereon.

41. A product, manufactured through baking in a mold at least partially wherein at least a first part (6, 36, 85) is provided wherein the first part (6, 36, 85) is at least substantially manufactured from a second mass whose composition deviates from the composition of at least one first mass from which said adjoining parts (2, 4, 32, 36, 48, 87, 89) are manufactured.

42. A product according to claim 41, having a foamy, blown structure, comprising a first product part (6, 36, 85) and a second product part (2, 4, 32, 36, 48, 87, 89), connected thereto via said first part (6, 36, 85), said first part (6, 36, 85) comprising a core (24) having relatively large blown cells, covered on two opposite sides by an outer layer (26) having relatively small cells and a compact structure, at least a portion of said first part (6, 36, 85) comprising, at least almost directly after formation of the product, in at least one of the outer layers (26), a softener in a concentration higher than that in the parts (2, 4, 32, 36, 48, 87, 89) adjoining said first part (6, 36, 85) and/or of a nature deviating from any softener in the adjoining parts (2, 4, 32, 36, 48, 87, 89) at least the relevant at least one outer layer (26) having a flexibility which is higher than the flexibility of the outer layer (26) of said adjoining parts (2, 4, 32, 36, 48, 87, 89).

43. A product according to any one of claims 41-42, wherein at least a portion of at least one outer layer (26) of said first part (6), 36, 85) is provided with at first coating (28), said adjoining parts (2, 4, 32, 36, 48, 87, 89) having at least one outer layer connecting to said outer layer, which is provided with a second coating, connecting to the relevant outer layer, said second coating being relatively closed, in particular closed to a component reactive with the mass from which the product, at least the first part, is manufactured, more in particular water proof and water resistant.

44. A product according to claim 43, wherein the second coating on the relevant outer layer is at least partially covered by the first coating.

45. A product according to claim 43-44, wherein the first coating is more flexible, in particular has a higher tensile strength than the second coating.

46. A product according to any one of claims 41-45, wherein the relevant first part (6, 36, 85) comprises at least one opening.

47. A product according to any one of claims 41-46, wherein said first part (6, 36, 85), in at least one of the outer layers and preferably at least one of the outer layers and an adjoining part of the core, comprises a concentration of softener which is greater than the concentration of softener of a comparable type in the parts (2, 4, 32, 36, 48, 87, 89) adjoining said first part (6, 36, 85).

48. A product according to claim 47, wherein the relevant softener is selected from a group of oils, fats, waxes, alcohols, sugars.

49. A product according to any one of claims 41-48, wherein the product in the first part (6, 36, 85) comprises a concentration and/or type of fibers and/or fibers in an orientation deviating from that in adjoining parts (2, 4, 32, 36, 48, 87, 89).

50. A injection molding apparatus specifically designed for carrying out so method according to any one of claims 1-40 comprising at least first injection means (64, 74, 84) for introducing a first mass into a mold (60, 70, 80) and at least second injection means (64, 74, 84) for introducing a second mass into the same mold (60, 70, 80), in particular suitable for use of biodegradable masses, wherein heating means are provided for the mold (60, 70, 80), at least means for connecting heating means of or for such mold.
